(19) United States
(12) Patent Application Publication
(10) Pub. No.: US 2009/0282283 A1
(43) Pub. Date: Nov. 12, 2009

(54) MANAGEMENT SERVER IN INFORMATION PROCESSING SYSTEM AND CLUSTER MANAGEMENT METHOD

(75) Inventors: Motoshi Sakakura, Yamato (JP); Yoshifumi Takamoto, Kokubunji (JP)

Correspondence Address: BRUNDIDGE & STANGER, P.C., 1700 DIAGONAL ROAD, SUITE 330, ALEXANDRIA, VA, 22314, US

(73) Assignee: Hitachi, Ltd.

(21) Appl. No.: 12/392,479

(22) Filed: Feb. 25, 2009

(30) Foreign Application Priority Data
May 9, 2008 (JP) 2008-123773

(51) Int. Cl. G06F 11/00; G06F 15/173

(52) U.S. Cl. 714/4; 709/223; 709/224; 714/E11.016; 714/E11.179; 714/47

(57) ABSTRACT

An information processing system includes I/O devices, I/O switches each of which is coupled to the I/O devices, multiple server apparatuses which are coupled to the I/O switch and with which a cluster can be constructed, and a management server. In the system, a management server is that: stores an identifier and a coupling port ID of the I/O switch to which any of the server apparatuses and any of the I/O devices are coupled; stores information as to whether or not each of the I/O devices can use loopback function for the heart beat signal; selects one of the I/O devices available for the loopback function in constructing the cluster between the server apparatuses; generates a heart beat path using the selected I/O device as a loopback point; and performs settings on the I/O device.

### CROSS-REFERENCE TO RELATED APPLICATIONS

The present application claims a priority from Japanese Patent Application No. 2008-123773 filed on May 9, 2008, the content of which herein incorporated by reference.

### BACKGROUND OF THE INVENTION

1. Field of the Invention

The present invention relates to a management server in an information processing system including multiple server apparatuses coupled to an I/O switch, and a cluster management method. In particular, the present invention relates to a technique for facilitating cluster construction and management.

2. Related Art

As an example of a computer including multiple processors, Japanese Patent Application Laid-open Publication No. 2005-301488 discloses a complex computer configured by multiple processors (server apparatuses) coupled to an I/O interface switch (I/O switch), and multiple I/O interfaces (i/O devices) for coupling to a local area network (LAN) or a storage area network (SAN) coupled to the I/O switch.

In constructing a high availability (HA) cluster for carrying out fail over between server apparatuses by using such a computer as mentioned above, it is necessary to secure a path (heart beat path) between the server apparatuses for transmitting and receiving heart beat signals. For this reason, an operator or the like has been forced to work on cumbersome operations.

For example, it was necessary to couple a physical communication line constituting a part of a heart beat path to a port of the I/O switch. In particular, in reconstructing the cluster, it is necessary to rewire the communication line each time on a site when the cluster is reconstructed. Therefore, burden on management is a problem in the case of a large scale system. In addition, extra ports of the I/O switch are inevitably used for establishing the heart beat paths.

### SUMMARY OF THE INVENTION

The present invention has been made in view of the foregoing problems. An object of the present invention is to provide a management server and a cluster management method capable of facilitating cluster construction and management in an information processing system.

To attain the above mentioned object, an aspect of the present invention provides a management server in an information processing system including at least one I/O device, an I/O switch to which the I/O device is coupled, a plurality of server apparatuses coupled to the I/O switch and capable of constructing a cluster, the management server managing the at least one I/O device, the I/O switch, and the plurality of server apparatuses, in the information processing system the at least one I/O device having a function to loopback a heart beat signal transmitted from one of the server apparatuses to another one of the server apparatuses, the management server comprising a heart beat path generating part that stores information on whether or not an identifier and a coupling port of the I/O switch to which the server apparatus and the I/O device are coupled, each of the I/O devices being enabled to use the loopback function for the heart beat signal, and selects one of the I/O devices enabled to use the loopback function and generates, as a path for the heart beat signal in the cluster, a path including a selected I/O device as a loopback point, when the cluster is configured between the server apparatuses, and an I/O device control part that sets the I/O device so that the selected I/O device performs loopback of the heart beat signal along the path.

Meanwhile, another aspect of the present invention provides the management server which further includes a hardware status check part that checks a status of the I/O device allocated to the server apparatus functioning as a takeover apparatus when a fail-over between the server apparatuses is performed in a case of disruption of the heart beat signal to be transmitted and received between the server apparatuses, and that deters the fail-over when there is an anomaly in the I/O device.

Still another aspect of the present invention provides the management server which further includes an I/O device blocking part that blocks a port of the I/O switch when there is a failure in a cluster resource of the server apparatus, the port of the I/O switch being coupled to the I/O device coupled to the cluster resource of the server apparatus with the failure.

Other problems disclosed in this specification and solutions therefor will become clear in the following detailed disclosure of the invention with reference to the accompanying drawings.

According to the present invention, it is possible to facilitate cluster construction and management in an information processing system provided with multiple server apparatuses coupled to an I/O switch.

### BRIEF DESCRIPTION OF THE DRAWINGS

FIG. 1 shows a configuration of an information processing system 1.

FIG. 2A shows an example of a hardware configuration of a management server 10.

FIG. 2B shows an example of a hardware configuration of a server apparatus 20.

FIG. 2C shows an example of a hardware configuration of a service processor (SVP) 30.

FIG. 2D shows an example of a hardware configuration of an I/O device 60.

FIG. 3A is a view showing functions and data included in the management server 10.

FIG. 3B is a view showing a software configuration of the server apparatus 20.

FIG. 3C is a view showing a function of the SVC 30.

FIG. 4A shows an example of an I/O switch management table 111.

FIG. 4B shows an example of a loopback media access control (MAC) address management table 112.

FIG. 4C shows an example of a server configuration management table 113.

FIG. 4D shows an example of a high availability (HA) configuration management table 114.

FIG. 5 shows a configuration of information processing system 1.

FIG. 6 shows an example of a MAC address registration table 115.

FIG. 7 is a flowchart explaining cluster construction processing S700.

FIG. 8 is a flowchart explaining heart beat path signal generation processing S710.

FIG. 9 is a flowchart explaining loopback I/O device allocation processing S810.

FIG. 10 is a flowchart explaining device information acquisition processing S910.

FIG. 11 is a flowchart explaining operations of a cluster control part 122 of the server apparatus 20.

FIG. 12 is a flowchart explaining I/O device blockage processing S1145.

FIG. 13 is a flowchart explaining hardware status check processing S1150.

### DETAILED DESCRIPTION OF THE INVENTION

Now, an embodiment of the present invention will be described below with reference to the accompanying drawings.

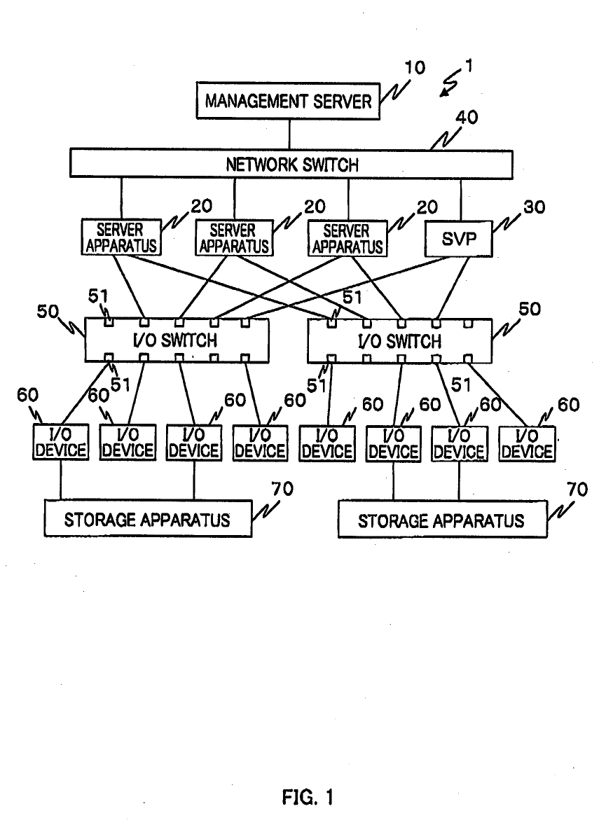

FIG. 1 shows a configuration of an information processing system 1 which is described as an embodiment of the present invention. As shown in FIG. 1, this information processing system 1 includes a management server 10, multiple server apparatuses 20, a service processor (SVP) 30, a network switch 40, I/O switches 50, I/O devices 60, and storage apparatuses 70.

As shown in FIG. 1, the management server 10 and the server apparatuses 20 are coupled to the network switch 40. Each of the server apparatuses 20 provides tasks and services to an external apparatus (not shown) such as a user terminal that accesses the server apparatus 20 through the network switch 40. The I/O switch 50 includes multiple ports 51. The server apparatuses 20 and the SVP 30 are coupled to predetermined ports 51 of the I/O switch 50. The storage apparatuses 70 are coupled to the rest of the ports 51 of the I/O switches 50 through the I/O devices 60. Each of the server apparatuses 20 can access any of the storage apparatuses 70 through the I/O switch 50 and the I/O device 60.

The I/O device 60 may be a network interface card (NIC), a fibre channel (FC) card, a SCSI (small computer system interface) card or the like. Here, in this information processing system 1, the server apparatuses 20 and the I/O devices 60 are independently provided. For this reason, correspondence between the server apparatuses 20 and any of the I/O devices 60 can be set flexibly. Moreover, it is also possible to increase or decrease the server apparatuses 20 and the I/O devices 60 individually.

The management server 10 is an information apparatus (a computer) configured to perform various settings, management, monitoring of operating status, and the like of the information processing system 1.

The SVP 30 communicates with the server apparatuses 20, the I/O switches 50, and the I/O devices 60. The SVP 30 also performs various settings, management, monitoring of operating status, information gathering, and the like of these components.

The storage apparatus 70 is a storage apparatus for providing the server apparatuses 20 with data storage areas. Typical examples of the storage apparatus 70 include a disk array apparatus configured by implementing multiple hard disks, and a semiconductor memory, for example.

As an example of the information processing system 1 having the above-described configuration there is a blade server configured by implementing multiple circuit boards (blades) so as to provide tasks and services to users.

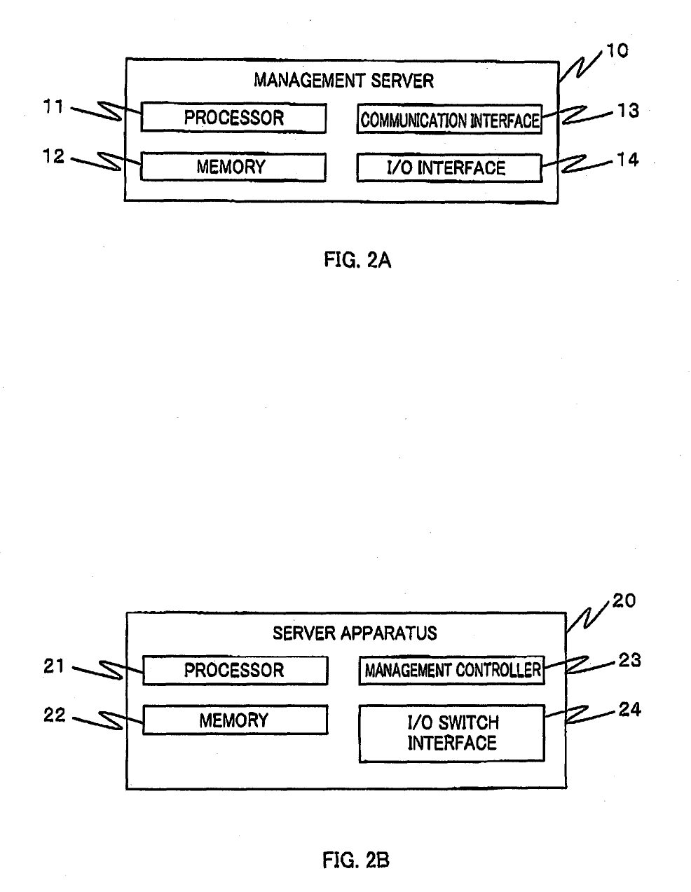

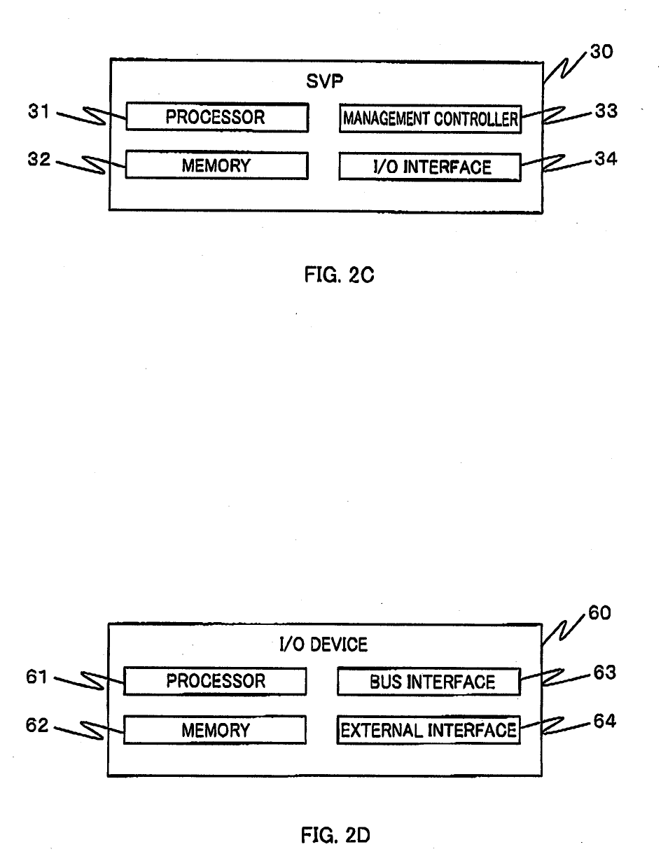

Next, hardware configurations of respective components in the information processing system 1 will be described. First, FIG. 2A shows a hardware configuration of the management server 10. As shown in FIG. 2A, the management server 10 includes a processor 11, a memory 12, a communication interface 13, and an I/O interface 14. Among them, the processor 11 is a central processing unit (CPU), a micro processing unit (MPU) or the like configured to play a central role in controlling the management server 10. The memory 12 is a random access memory (RAM), a read-only memory (ROM) or the like configured to store programs and data. The communication interface 13 performs communication with the server apparatuses 20, the SVP 30, and the like through the network switch 40. The I/O interface 14 is an interface for coupling an external storage apparatus configured to store data and programs for starting the management server 10.

FIG. 2B shows a hardware configuration of the server apparatus 20. The server apparatus 20 includes a processor 21, a memory 22, a management controller 23, and an I/O switch interface 24. The processor 21 is a CPU, a MPU or the like configured to play a central role in controlling the server apparatus 20. The memory 22 is a RAM, a ROM or the like configured to store programs and data.

The management controller 23 is a baseboard management controller (EMC), for example, which is configured to monitor an operating status of the hardware in the server apparatus 20, to collect failure information, and so forth. The management controller 23 notifies SVP 30 or an operating system running on the server apparatus 20 of a hardware error that occurs in the server apparatus 20. The notified hardware error is an anomaly of a supply voltage of a power source, an anomaly of revolutions of a cooling fan, an anomaly of temperature or power source voltage in each device, or the like. Here, the management controller 23 is highly independent from the other components in the server apparatus 20 and is capable of notifying the outside of a hardware error when such a failure occurs in any of the other components such as the processor 21 and the memory 22. The I/O switch interface 24 is an interface for coupling the I/O switches 50.

FIG. 2C shows a hardware configuration of the SVP 30. As shown in FIG. 2C, the SVP 30 includes a processor 31, a memory 32, a management controller 33, and an I/O interface 34. The processor 31 is a CPU, an MPU or the like configured to play a central role in controlling the SVP 30. The memory 32 is a RAM, a ROM or the like configured to store programs and data. The management controller 33 is a device for monitoring status of the hardware in the SVP 30, which is a BMC as previously described, for example. The I/O interface 34 is an interface to which there is coupled an external storage apparatus where programs for starting the SVP 30 and data are stored.

FIG. 2D shows a hardware configuration of the I/O device 60. As shown in FIG. 2D, the I/O device 60 includes a processor 61, a memory 62, a bus interface 63, and an external interface 64. The processor 61 is a CPU, an MPU or the like configured to perform protocol control of communication with the storage apparatus 70. The protocol control corresponds to protocol control of LAN communication such as TCP/IP when the I/O device 60 is a NIC, and corresponds to fiber channel protocol control when the I/O device 60 is an HBA (Host Bus Adapter).

The memory 62 of the I/O device 60 stores a MAC address registration table 115 to be described later. The bus interface 63 performs communication with the server apparatuses 20 through the I/O switches 50. The external interface 64 is an interface configured to communicate with the storage apparatuses 70. Here, the I/O device 60 includes a loopback function of heart beat signals which is implemented by the above-described hardware and by software to be executed by the hardware. Details of this loopback function will be described later.

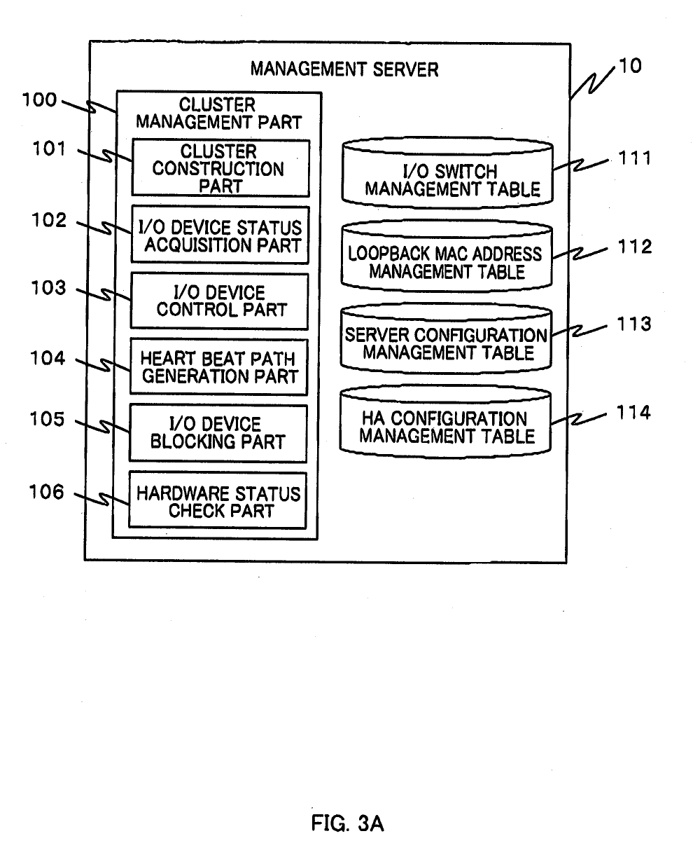

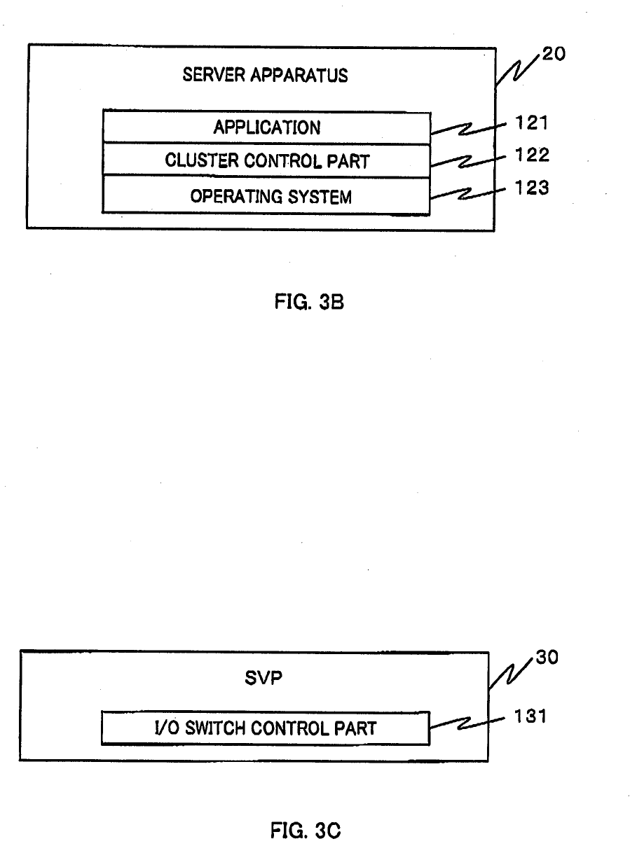

FIG. 3A shows functions and data included in the management server 10. The management server 10 includes a cluster management part 100 configured to manage a high availability (HA) cluster to be constructed among the server apparatuses 20. As shown in FIG. 3A, the cluster management part 100 includes a cluster construction part 101, an I/O device status acquisition part 102, an I/O device control part 103, a heart beat path generating part 104, an I/O device blocking part 105, and a hardware status check part 106. Note that these functions are implemented by the hardware of the management server 10 or by the reading and executing of the programs stored in the memory 12 by the processor 11. Meanwhile, the management server 10 stores an I/O switch management table 111, a loopback MAC address management table 112, a server configuration management table 113, and a HA configuration management table 114.

FIG. 3B shows a software configuration of the server apparatus 20. As shown in FIG. 3B, an operating system 123 is installed in the server apparatus 20, and a cluster control part 122 representing a function to perform control concerning a fail-over performed among the server apparatuses 20 and an application 121 for providing services to user terminals and the like are operated on the server apparatus 20. Here, the cluster control part 122 is implemented by the hardware of the server apparatus 20 or by the reading and executing the programs stored in the memory 22 by the processor 21. Details of the cluster control part 122 will be described later.

FIG. 3C shows a function of the SVC 30. As shown in FIG. 3C, the SVP 30 implements an I/O switch control part 131 representing a function to control the I/O switch 50, which is implemented by the hardware of the SVP 30 or by executing the programs stored in the memory 32 by the processor 31.

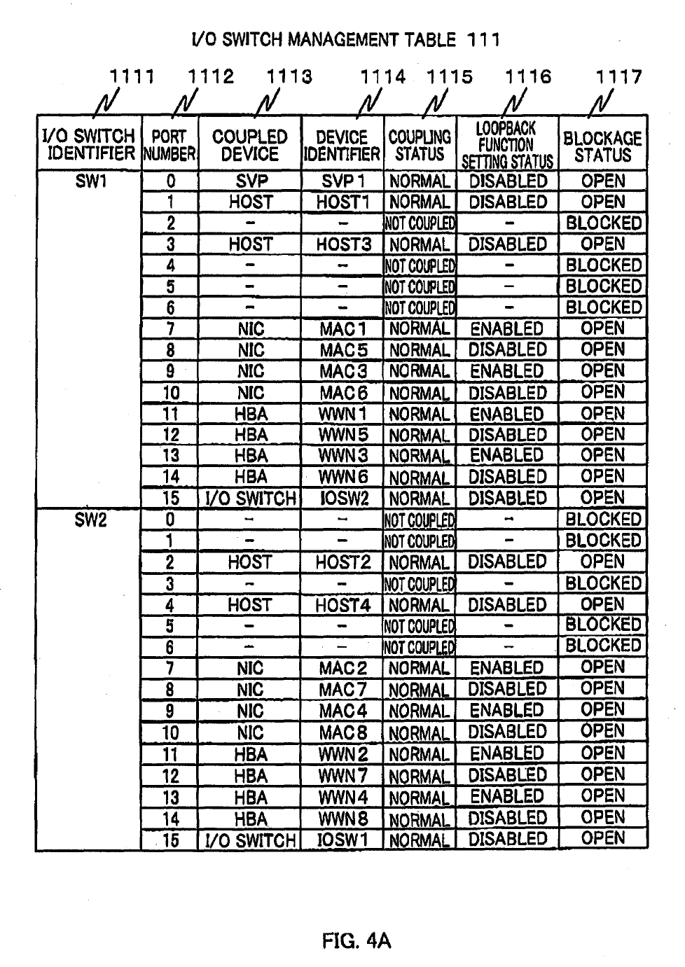

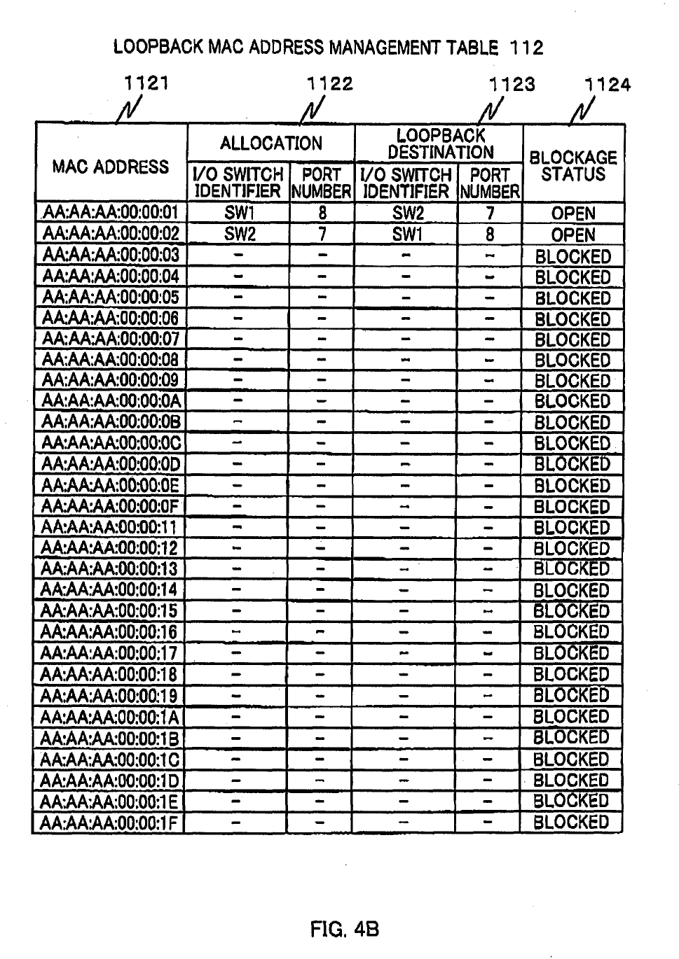

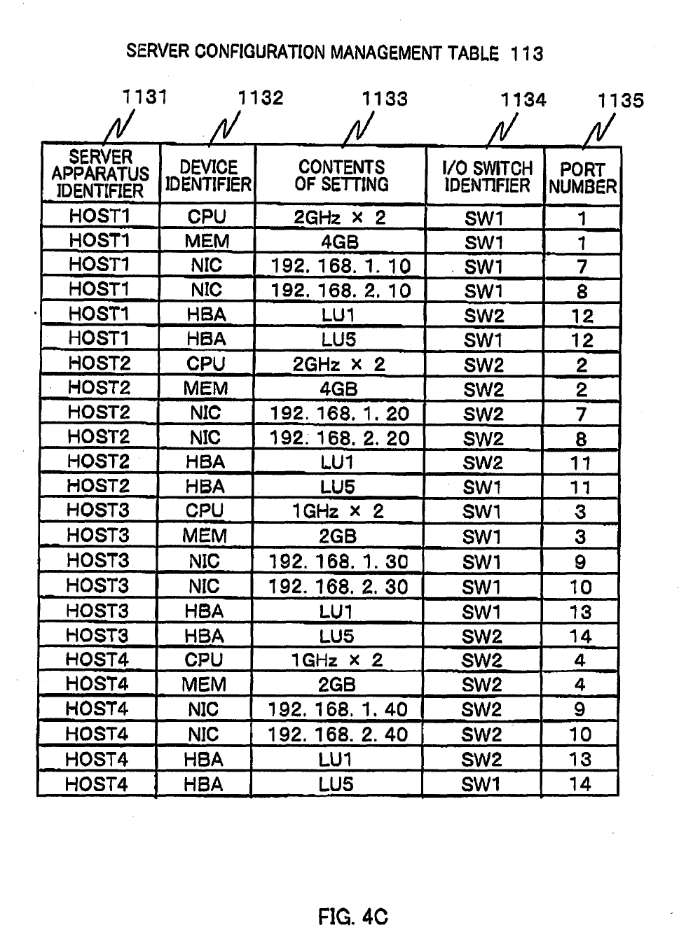

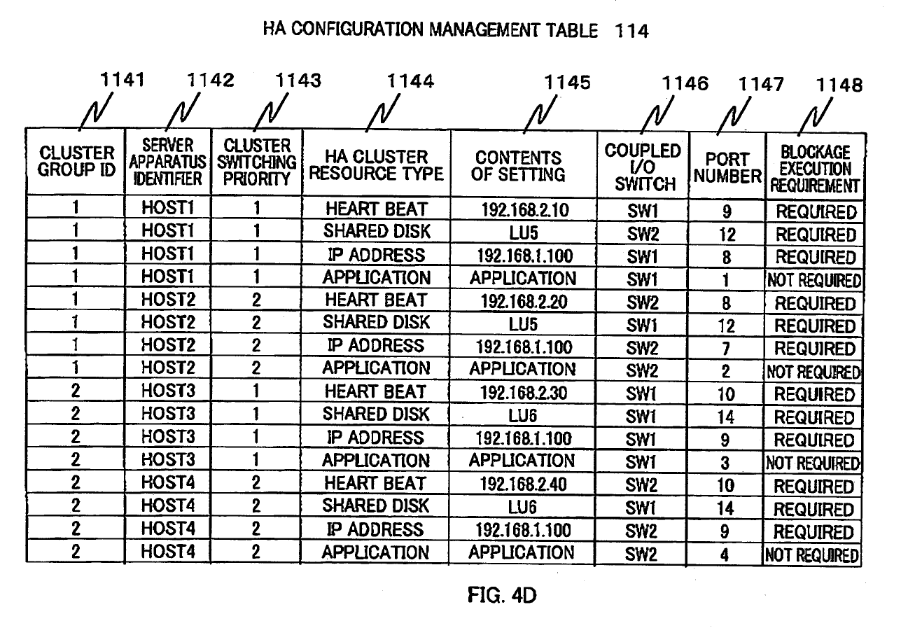

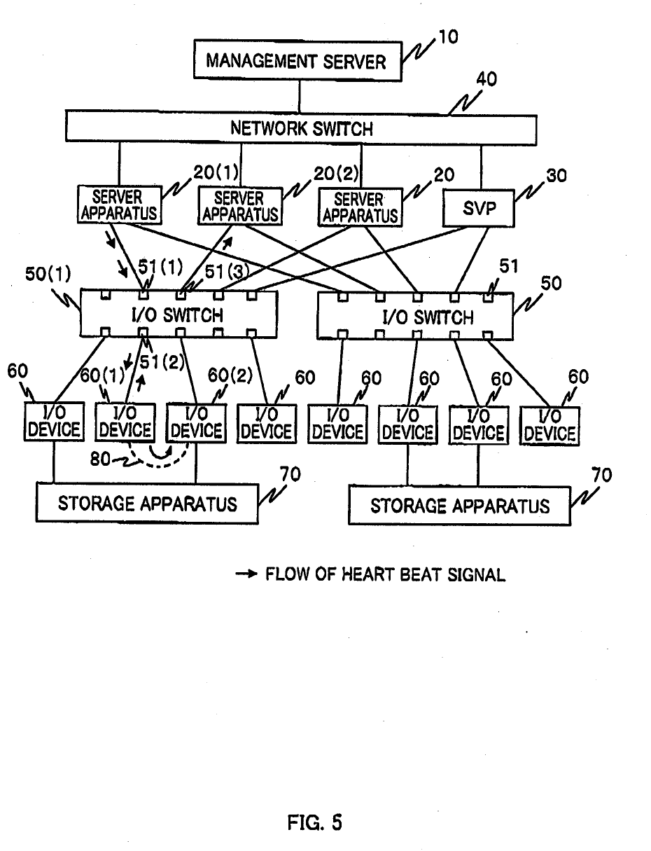

FIG. 4A shows an example of the I/O switch management table 111. As shown in FIG. 4A, the I/O switch management table 111 includes columns of I/O switch identifier 1111, port number (port ID) 1112, coupled device 1113, device identifier 1114, coupling status 1115, loopback function setting status 1116, and blockage status 1117. Here, the management server 10 acquires the contents of the I/O switch management table 111 from the I/O switches 50 either directly or indirectly via the SVP 30.

Identifiers of the I/O switches 50 are set in the column I/O switch identifier 1111. Numbers for each specifying the port 51 of the I/O switch 50 are set in the column port number 11-12. In the case of FIG. 4A, the I/O switch 50 having the identifier of “SW1” is provided with 16 ports 51, for example.

The types of device coupled to the respective ports 51 are set in the coupled device 1113. For instance, “SVP” is set therein when the SVP 30 is coupled, “host” is set therein when a host (a user terminal) is coupled, “NIC” is set therein when a NIC is coupled, “HBA” is set therein when a HBA is coupled, and “I/O switch” is set therein when the I/O switch 50 is coupled (this is a case of cascade-coupling the I/O switches 50, for example). Meanwhile, a mark “-” is set therein when nothing is coupled.

Information for identifying the devices coupled to the respective ports 51 are set in the column device identifier 1114. For instance, the name of the SVP is set therein when the SVP 30 is coupled, the name of the host (the user terminal) is set therein when the host is coupled, a MAC address of the NIC is set therein (expressed in the form of “MAC 1” and so forth in the drawing) when the NIC is coupled, a WWN (world wide name) attached to the HBA is set therein (expressed in the form of “WWN 1” and so forth in FIG. 4A) when the HBA is coupled, and the name of the I/O switch 50 is set therein when the I/O switch 50 is coupled. Meanwhile, a mark “-” is set therein when nothing is coupled.

Information indicating status of the devices coupled to the respective ports 51 is set in the column coupling status 1115. For instance, “normal” is set therein when the device is operating normally, “abnormal” is set therein when the device is not operating normally, and “not coupled” is set therein when nothing is coupled.

When any of the I/O devices 60 is coupled to any of the respective ports 51, information indicating setting status of the loopback function to be described later concerning the respective I/O devices 60 is set in the column loopback function setting status 1116. “Enabled” is set therein when the loopback function is set, and “disabled” is set therein when the loopback function is not set. Here, the mark “-” is set therein when nothing is coupled to the port 51.

Blockage status concerning each of the ports 51 (as to where the port 51 is available or not) is set in the column blockage status 1117. “Open” is set therein when the port 51 is not blocked whereas “blocked” is set therein when the port 51 is blocked.

Here, as described above, the management server 10 manages the information on the I/O switches 50 by use of the I/O switch management table 111. Accordingly, for example, when a failure occurs on the I/O switch 50 or the I/O device coupled to the I/O switch 50, it is possible to obtain the information necessary for fixing the failure, such as the identifier of the device where the failure occurs.

FIG. 4B shows an example of the loopback MAC address management table 112. In the loopback MAC address management table 112, there are registered MAC addresses attached to the respective I/O devices 60 in the loopback function to be described later and information on path setting of the I/O switches 50 in the loopback function.

As shown in FIG. 4B, the loopback MAC address management table 112 includes columns MAC address 1121, allocation 1122, loopback destination 1123, and blockage status 1124.

Among them, the loopback MAC addresses to be attached to the respective I/O devices 60 concerning the loopback function to be described later are set in the column MAC address 1121.

The identifiers and numbers of the ports 51 of each of the I/O switches 50 coupled to the I/O devices 60 to which the loopback MAC addresses are allocated, are set in the column allocation 1122.

The identifiers and numbers of the ports 51 of each of the I/O switches 50 representing destinations of the signals made to loopback by the I/O devices 60 to which the loopback MAC addresses are attached are set in the column loopback destination 1123.

Blockage status of paths specified according to setting contents of the allocation 1122 and the loopback destination 1123 columns are set in the column blockage status 1124. “Open” is set therein when the path is not blocked whereas “blocked” is set therein when the path is blocked.

FIG. 4C shows an example of the server configuration management table 113. The server configuration management table 113 has registered therein information on configurations of the server apparatuses 20. As shown in FIG. 4C, the server configuration management table 113 includes columns for server apparatus identifier 1131, device identifier 1132, contents of setting 1133, I/O switch identifier 1134, and port number 1135.

Among them, the identifiers of the server apparatuses 20 are set in the column server apparatus identifier 1131. The identifiers of the devices included in the server apparatuses 20 are set in the column device identifiers 1132. For instance, “CPU” is set therein when the device is a CPU, “MEM” is set therein when the device is a memory, “NIC” is set therein when the device is a NIC, and “HBA” is set therein when the device is an HBA. Here, a record in the server configuration management table 113 is generated in units of devices.

A variety of information on the devices is set in the column contents of setting 1133. For instance, the frequency of an operating clock and the number of cores of the CPU are set therein when the device is a CPU, the storage capacity is set therein when the device is a memory, an IP address is set therein when the device is a NIC, and an identifier of a logical unit (LU) of an access destination is set therein when the device is an HBA.

The identifiers of the I/O switches 50 to which the devices are coupled are set in the column I/O switch identifiers 1134. The numbers of the ports 51 to which the devices are coupled are set in the column port number 1135.

FIG. 4D shows an example of the HA configuration management table 114. The HA configuration management table 114 has registered therein information on HA clusters configured among the server apparatuses 20. As shown in FIG. 4D, the HA configuration management table 114 includes columns for cluster group ID 1141, server apparatus identifier 1142, cluster switching priority 1143, HA cluster resource type 1144, contents of setting 1145, coupled I/O switch 1146, port number 1147, and blockage execution requirement 1148.

Among them, the identifiers to be attached to the respective clusters are set in the column cluster group ID 1141. The identifiers of the server apparatuses 20 are set in the column server apparatus identifier 1142. Priorities at the time of cluster switching are set in the column cluster switching priority 1143. Here, a smaller value represents higher priority as a switching destination. The types of resources in the HA clusters to be taken over to their destinations at the time of carrying out fail-over are set in the column HA cluster resource type 1144. For instance, “heart beat” is set therein when the resource is a heart beat, “shared disk” is set therein when the resource is a shared disk, “IP address” is set therein when the resource is an IP address, and “application” is set therein when the resource is an application.

The contents set to the resources are set in the column contents of setting 1145. For instance, an IP address used for communicating a heart beat signal is set therein when the resource is a heart beat and an identifier of a LU is set therein when the resource is a shared disk.

The identifiers of the I/O switches 50 to which the server apparatuses 20 are coupled are set in the column coupled I/O switch 1146. The numbers of the ports 51 of each of the I/O switches so to which the server apparatuses 20 are coupled are set in the column port number 1147.

Information indicating whether or not it is necessary to block the ports 51 is set in the column blockage execution requirement 1148. “Required” is set therein when blockage is required and “not required” is set therein when blockage is not required.

### Loopback Function

As described above, the I/O device 60 of the present embodiment has the loopback function to route the heart beat signal to be transmitted and received between the server apparatuses 20 configuring the HA cluster and is capable of serving as a loopback point of the heart beat signal to be transmitted and received between the server apparatuses 20. For example, as shown in FIG. 5, a heart beat signal transmitted from a server apparatus 20(1) is inputted to a port 51(1) of an I/O switch 50(1), then outputted from a port 51(2), and subsequently inputted to an I/O device 60(1). Thereafter, this heart beat signal is made to loopback by the I/O device 60(1) set up to enable the loopback function and inputted from the port 51(2) to the I/O switch 50(1), and is outputted from a port 51(3) and reaches a server apparatus 20(2). By providing this loopback function, it is possible to loopback the heart beat signal toward the partner server apparatus 20 by using the single I/O device 60 without installing a communication line (a communication line indicated with reference numeral 80 in FIG. 5) linking the I/O devices 60 to each other in order to form a heart beat path.

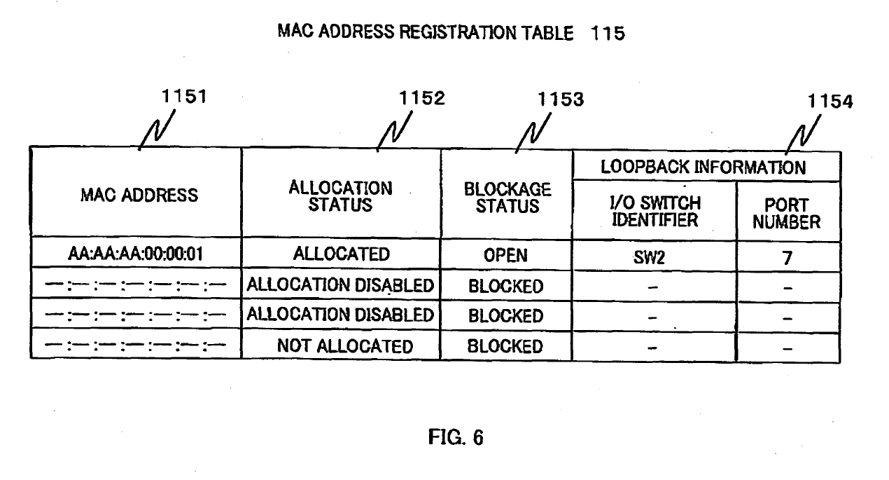

FIG. 6 is a table (hereinafter referred to as a MAC address registration table 115) that the I/O device 60 stores in the memory 52. As shown in FIG. 6, this MAC address registration table 115 includes columns for MAC address 1151, allocation status 1152, blockage status 1153, and loopback information 1154.

Among them, the MAC addresses to be allocated to the respective I/O devices 60 are stored in the column MAC address 1151. Statuses of allocation of the MAC addresses are set in the column allocation status 1152. “Allocated” is set therein when the MAC address is allocated to the loopback function, “not allocated” is set therein when the MAC address is allocatable for the loopback function but has not been allocated thereto yet, and “allocation disabled” is set therein in the case of the MAC address whose allocation to the loopback function is restricted.

Blockage statuses of the MAC addresses (as to whether or not the MAC addresses are available for loopback) are set in the column blockage status 1153. “Open” is set therein when the MAC address is available for loopback and “blocked” is set therein when the MAC address is not available. In this way, the I/O device 60 can be blocked in units of the assigned MAC address. Here, the contents of the column blockage status 1153 are appropriately set up according to the operating status or the like of the information processing system 1.

In the column loopback information 1154, the identifiers of the I/O switches 50 being the respective loopback destinations are set in the column I/O switch identifier, and numbers of the ports 51 of each of the I/O switches 50 being the loopback destinations are set in the column port number. Here, the contents of the column loopback information 1154 correspond to the contents of the column loopback destination 1123 of the loopback MAC address management table 112 in the management server 10.

### Description of Operations

Next, detailed operations of the information processing 30 system 1 will be described with reference to flowcharts. In the following description, the letter “S” prefixed to each reference numerals stands for step.

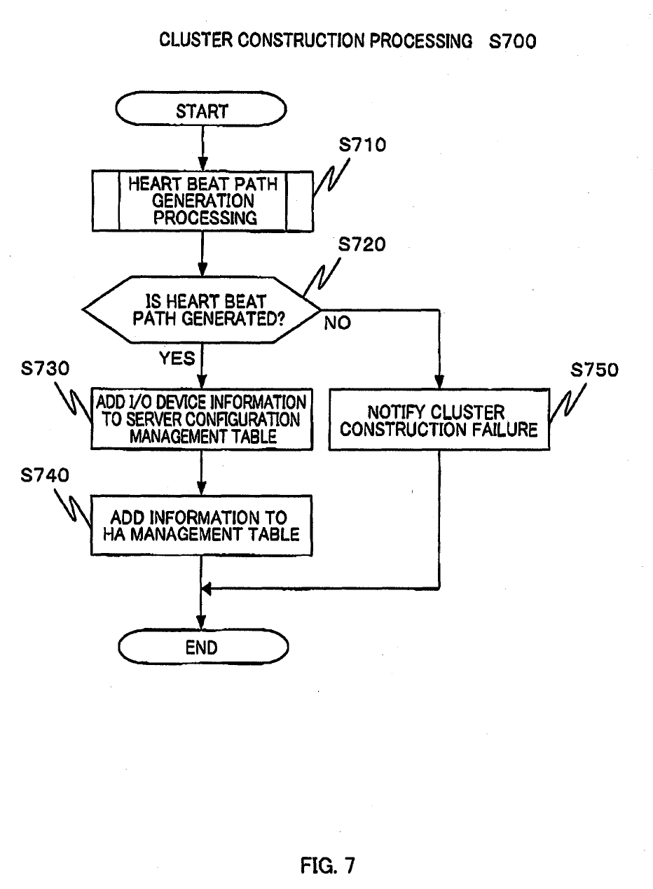

FIG. 7 is a flowchart describing processing of construction of a cluster between the server apparatuses 20 by the cluster management part 100 of the management server 10 (hereinafter referred to as cluster construction processing S700). This cluster construction processing S700 is executed at the time of installation of the information processing system 1 or a configuration change (such as an increase or a decrease of) the server apparatuses 20, for example.

First, the cluster construction part 101 of the cluster management part 100 calls the heart beat path generating part 104 and generates a heart beat path between the server apparatuses 20 that configure the cluster. This processing will be hereinafter referred to as heart beat path generation processing S710.

After execution of the heart beat path generation processing S710, the cluster construction part 101 judges whether or not the heart beat path is generated as a result of the heart beat path generation processing S710 (S720). The process goes to S730 when the heart beat path is generated successfully (S720: YES), or the process goes to S750 when the heart beat path is not generated (S720: NO).

Next, the cluster construction part 101 reflects, to the server configuration management table 113, the information on the I/O devices 60 existing on the generated heart beat path (S730). Meanwhile, the cluster construction part 101 reflects the information on the configured cluster to the HA configuration management table 114 (S740).

On the other hand, in S750, the cluster construction part 101 notifies a request source (such as a program which had called the cluster construction processing S700, an operator of the management server 10, or the like) that the cluster construction had failed (or the heart beat path could not be generated).

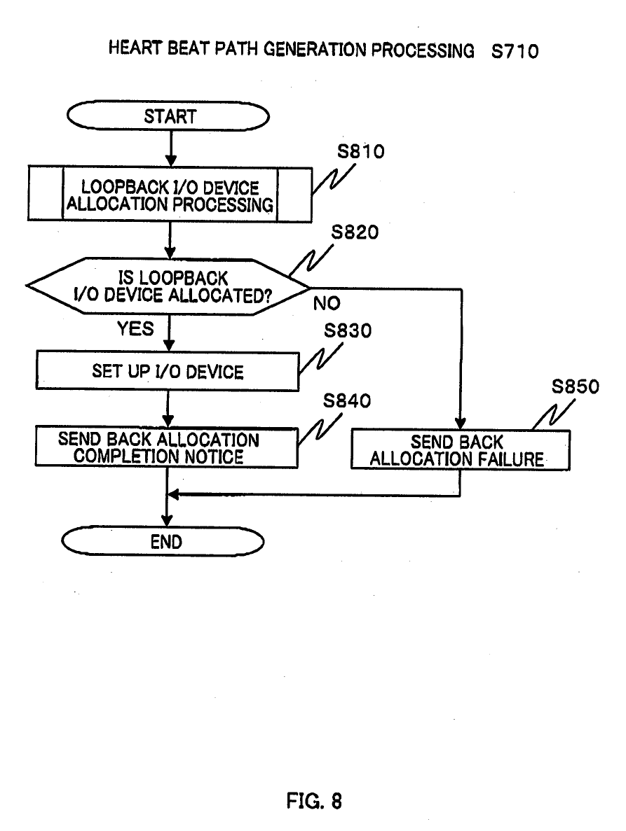

FIG. 8 is a flowchart explaining the above-described heart beat path generation processing S710.

First, the heart beat path generating part 104 of the cluster management part 100 calls the I/O device control part 103 of the cluster management part 100 and sets up an I/O device 60 to be used in the cluster to be set up this time, for heart beat loopback. This processing will be hereinafter referred to as loopback I/O device allocation processing S810.

After execution of the loopback I/O device allocation processing S810, the heart beat path generating part 104 judges whether or not the I/O device 60 for loopback was successfully allocated (S820). The process goes to S830 when the loopback I/O device 60 is successfully allocated (S820: YES), or the process goes to S850 when the loopback I/O device 60 is not successfully allocated (S820: NO).

In S830, the heart beat path generating part 104 performs setting necessary for the allocated I/O device 60. For instance, when the I/O device 60 is a NIC, an IP address is allocated to the NIC. Subsequently, in S840, the heart beat path generating part 104 sends back a notification to the cluster construction part 101 stating that allocation to the I/O device 60 is completed.

On the other hand, in S850, the heart beat path generating part 104 sends back a notification to the cluster construction part 101 stating that allocation to the I/O device 60 had failed.

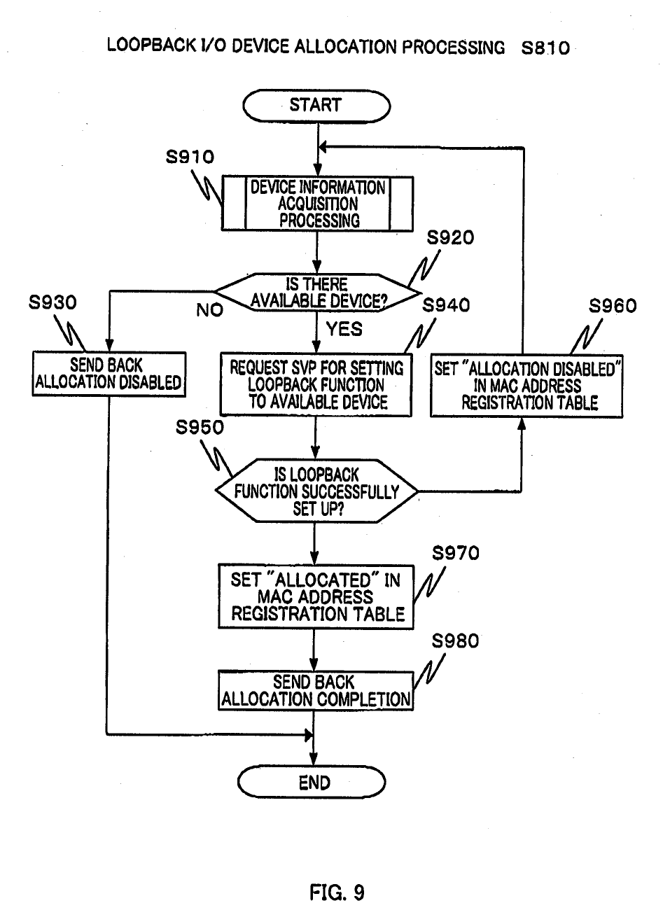

FIG. 9 is a flowchart for explaining the above-described loopback I/O device allocation processing S810.

First, the I/O device control part 103 of the cluster management part 100 calls the I/O device status acquisition part 102 of the cluster management part 100 and acquires information on the I/O device available for allocation (herein after referred to as an available device). This processing will be hereinafter referred to as device information acquisition processing S910.

After execution of the device information acquisition processing S910, the I/O device control part 103 judges whether or not there is a device available on the basis of the result of the device information acquisition processing S910 (S920). The process goes to S930 if there is no available device (S920: NO) and sends back a notification to the heart beat path generating part 104 stating that the I/O device 60 cannot be allocated. The process goes to S940 when there is an available device (S920: YES).

In S940, the I/O device control part 103 requests the SVP 30 to set up the loopback function for the heart beat signal on one of the available devices acquired in the device information acquisition processing S910.

In S950, the I/O device control part 103 judges whether or not the loopback function is set up based on a response from the SVP 30 to the above mentioned request. The process goes to S960 when the loopback function is not set up (S950: NO) or the process goes to S970 when the loopback function is successfully set up (S950: YES).

In S960, the I/O device control part 103 and the cluster control part 122 of the server apparatus 20 (or the SVP 30) set “allocation disabled” in allocation status 1152 corresponding to the MAC address 1151 of the available device which could not be up in this session, in the MAC address registration table 115. By setting “allocation disabled” for the MAC address that could not be set up as described above, it is possible to exclude the MAC address from a group of candidates in a subsequent judgment session, thereby enabling to efficiently construct the cluster thereafter.

In S970, the I/O device control part 103 and the cluster control part 122 of the server apparatus 20 (or the SVP 30) update the contents of the MAC address registration table 115 corresponding to the available device set up for the loopback function. Specifically, the I/O device control part 103 and the cluster control part 122 of the server apparatus 20 select one of the MAC addresses that has “not allocated” in allocation status 1152, and set “allocated” in allocation status 1152, “open” in blockage status 1153, and the contents corresponding to the server apparatus 20 of the loopback destination in loopback information 1154.

S In S980, the I/O device control part 103 sends back notification to the heart beat path generating part 104 stating that allocation of the I/O device 60 is completed.

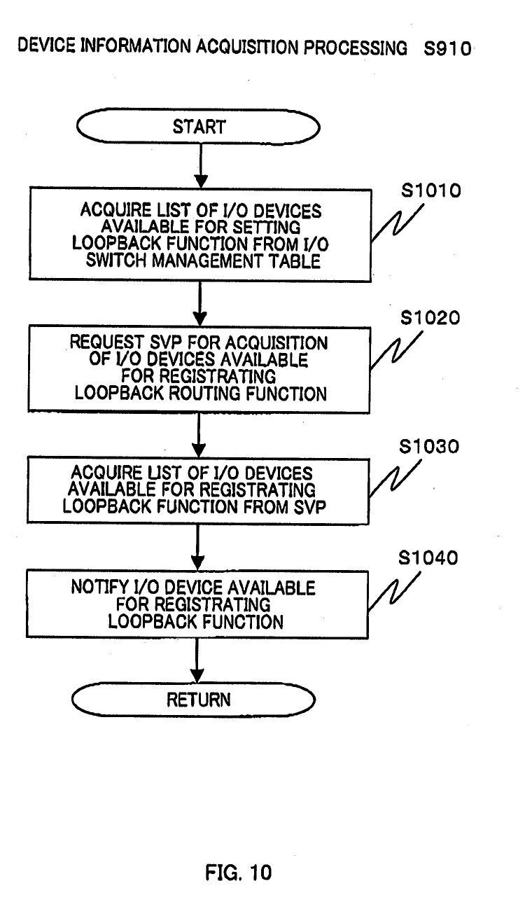

FIG. 10 is a flowchart explaining the aforementioned device information acquisition processing S910.

First, the I/O device status acquisition part 102 acquires a list of the I/O devices 60 available for setting the loopback function from the I/O switch management table 111 (S1010). Here, a judgment as to whether or not the I/O device 60 is available for setting the loopback function is made on the basis of the contents of the column loopback function setting status 1116. For example, the I/O device 60 is judged to be available for setting the loopback function when “disabled” is set in the column (the case where the loopback function is not set up) while the I/O device 60 is judged to be unavailable for setting the loopback function when “enabled” or the mark “-” is set in the column.

Next, the I/O device status acquisition part 102 transmits, to the SVP 30, an acquisition request for the I/O devices 60 available for registering the loopback function which are in the list of the I/O devices 60 available for setting the loopback function acquired in S1010 (S1020), and acquires a list of the I/O devices 60 available for registering the loopback function, from the SVP 30 (S1030). Here, the judgment as to whether or not the I/O device 60 is available for registering the loopback function is made by checking whether or not there is a MAC address for which “not allocated” is set in the column allocation status 1152 in the MAC address registration table 115 of the I/O device 60 available for setting the loopback function, for example.

In S1040, the I/O device status acquisition part 102 sends back a notification of one of the I/O devices 60 available for registering the loopback function to the I/O device control part 103. Here, when there are two or more I/O devices 60 available for registering the loopback function, the I/O device status acquisition part 102 selects an I/O device 60 to be notified to the I/O device control part 103 in accordance with a predetermined policy such as the descending order or the ascending order of the identifiers of the I/O devices 60, for example.

According to the above-described process, a heart beat path including the I/O device 60 as the loopback point can be generated when the cluster management part 100 constructs the cluster between the server apparatuses 20. In this way, it is possible to form the heart beat path easily without providing a communication line 80 separately in order to perform loopback of the heart beat signal as in the related art. Moreover, the heart beat path can be formed easily by using a signal I/O device 60 without relaying the heart beat signal through multiple I/O devices 60.

### Operations of Cluster Control Part

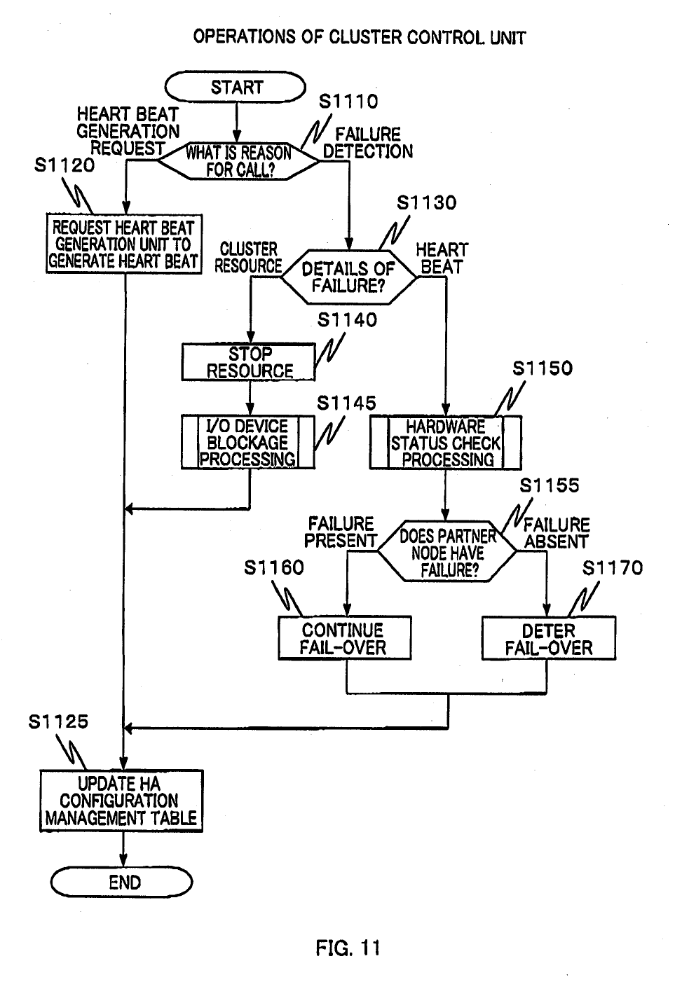

Next, operations of the cluster control part 122 of the server apparatus 20 will be described. FIG. 11 is a flowchart explaining operations of the cluster control part 122 when the cluster control part 122 is called by the management server 10, the SVP 30, the application 121, the operating system 123 or the like.

When thus called, the cluster control part 122 firstly judges a reason for the call (S1110). The process goes to S1120 when the reason for the call is “request to generate the heart beat path” (S1110: YES) or goes to S1130 when the reason for the call is “detection of a failure” (S1110: NO).

In S1120, the cluster control part 122 transmits a request for generating the heart beat path to the heart beat path generating part 104 of the management server 10. Here, after generating the heart beat path, the contents of the HA configuration management table 1114 in the management server 10 are updated (S1125).

In S1130, the cluster management part 122 determines the details of the failure. The process goes to S1140 when the failure relates to a cluster resource (such as the storage apparatus allocated to the server apparatus 20, the IP address or the application 121 of the server apparatus 20) (S1130: cluster resource), or goes to S1150 when the failure is due to disruption of the heart beat signal (S1130: heart beat).

In S1140, the cluster control part 122 stops the operation of the resource with the failure, and in subsequent S1145, the cluster control part 122 calls the I/O device blocking part 105 of the management server 10 to block the I/O device 60. Details of this processing (hereinafter referred to as I/O device blockage processing S1145) will be described later. Thereafter, the process goes to S1125.

By contrast, in S1150, the cluster control part 122 calls the hardware status check part 106 of the management server 10 and checks the status of the I/O device 60 used by the partner server apparatus 20 in the cluster (such a server apparatus will be hereinafter referred to as a partner node). Details of this processing (hereinafter referred to as hardware status check processing S1150) will be described later.

In Subsequent S1155, the cluster control part 122 judges whether or not there is an error in the I/O device 60 used by the partner node on the basis of the result of the hardware status check processing S1150. When there is a failure in the I/O device 60 used by the partner node (S1155: failure present), fail-over processing (takeover by the partner node) is continued (S1160). When there is no failure (S1155: failure absent), the fail-over processing is deterred (S1170). Thereafter, the process goes to S1125.

As described above, when the content of the failure is due to disruption of the heart beat signal, the cluster control part 122 continues the fail-over if the I/O device 60 used by the partner node does not have any failure. Instead, the cluster control part 122 controls the fail-over if there is the failure in the I/O device 60. Since the cluster control part 122 is operated as described above, it is possible to prevent unnecessary execution of the fail-over if the reason for the failure solely belongs to the I/O device 60 and there is no failure on the server apparatus 20.

Here, in S1130, the status of the I/O device 60 is checked when the detail of the failure is disruption of the heart beat signals. Instead, it is also possible to form the heart beat path to use a different I/O device 60 as the loopback point by executing S1120 and to deter the fail-over at the same time.

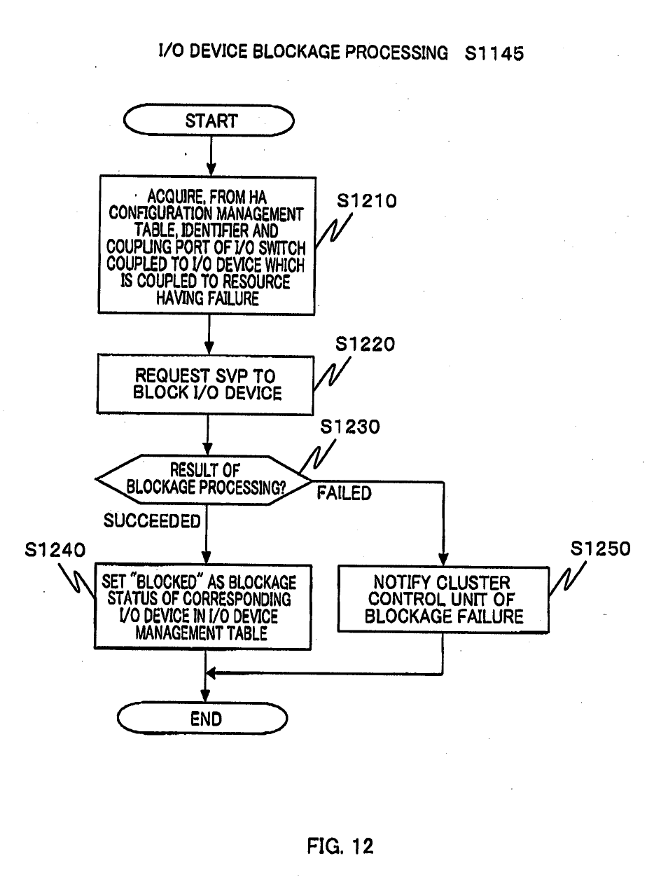

FIG. 12 is a flowchart for explaining the above-described I/O device blockage processing S1145.

First, the I/O device blocking part 105 of the management server 10 acquires the identifier of the I/O switch 50 (the content in the column coupled I/O switch 1146) for coupling the I/O device 60 that is coupled to the resource causing the failure and the port number (the content in the column port number 1147) (S1210).

Next, the I/O device blocking part 105 transmits a request for blocking the I/O device 60 specified by the identifier of the I/O switch 50 and the port number thereof acquired in S1210 to the SVP 30 (S1220).

The I/O device blocking part 105 receives a result of the blockage processing of the I/O device 60 from the SVP 30 and then judges whether or not the blockage processing was successful (S1230). When the blockage processing is successful (S1230: succeeded), the I/O device blocking part 105 sets “blocked” in the column blockage status 1117 corresponding to the I/O device 60 subject to blockage on the I/O switch management table 111 (S1240). When the blockage process is not successful (S1230: failed), the I/O device blocking part 105 notifies the cluster control part 122 of the failure of the blockage processing (S1250).

If the failure occurs in the server apparatus 20 in the related art, it is necessary to reboot (reset) the server apparatus 20 for carrying out the fail-over. As a consequence, the information in the memory of the server apparatus 20 may be deleted and it is not always possible to acquire sufficient information useful for specifying a cause of the failure. However, according to the I/O device blockage processing S1145, it is possible to selectively block only the I/O device 60 used by the cluster resource. Therefore, it is not necessary to reboot the server apparatus 20 and is possible to acquire the information necessary for specifying the cause of the failure such as core dump by accessing the server apparatus 20 after the fail-over, for example.

Meanwhile, in a system configured to generate the core dump automatically at the time of occurrence of a failure, it is usually impossible to stop the server apparatus 20 before the core dump is outputted to a file, and the server apparatus 20 for taking over the failed system cannot start the takeover processing before the file output. However, according to the I/O device blockage processing S1145, it is possible to block only the I/O device 60 and to isolate the server apparatus 20 causing the failure from other resources. For this reason, the server apparatus 20 for taking over the failed system can start the takeover processing even before the core dump is outputted to the file. Therefore, it is possible to reduce the time required for accomplishing the takeover.

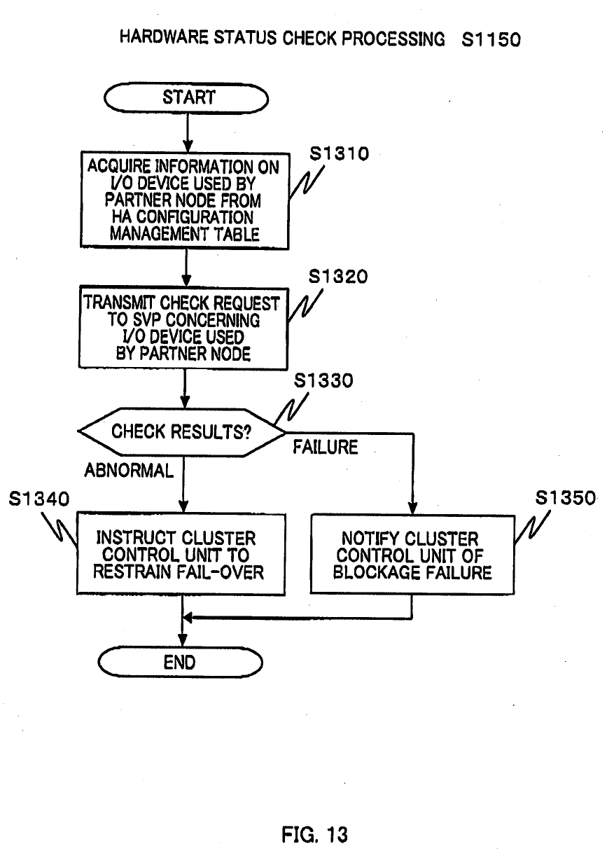

FIG. 13 is a flowchart for explaining the hardware status check processing S1150 in FIG. 11.

First, the hardware status check part 106 acquires the information on the I/O device 60 used by the partner node from the HA configuration management table 114 (S1310). Next, the hardware status check part 106 transmits, to the SVP 30, a request for checking the status of the I/O device 60 used by the partner node (S1320).

Next, the hardware status check part 106 judges the result of the status check received from the SVP 30 (S1330) and instructs the cluster control part 122 to deter the fail-over when there is an anomaly (S1330: abnormal) (S1340). When there is no anomaly (S1330; normal), the hardware status check part 106 instructs the cluster status check part 122 to continue the fail-over (S1350).

In this way, it is possible to automatically generate the heart beat path for transmitting and receiving heart beat signals between the server apparatuses 20 on the basis of the configuration where the I/O switches 50 are arranged in the center of the information processing system 1. Moreover, the generated path includes a single I/O device 60 having the function of making loopback the heart beat signal as the loopback point, and is not configured to relay signals through multiple I/O devices 60. Accordingly, this eliminates the necessity for separately providing a communication line for coupling the I/O devices 60 to each other in order to form the heart beat path, and avoids using up the ports of the I/O switches. Hence, it is possible to generate the heart beat path efficiently without changing the physical configuration of the information processing system 1. Therefore, the cluster in the information processing system 1 can be configured and managed easily and efficiently.

Note that the above-described embodiment is intended to facilitate understanding of the present invention but not to limit the invention. It is needless to say that various modifications and improvements are possible without departing from the scope of the invention, and equivalents thereof are also encompassed by the invention.

What is claimed is:

1. A management server in an information processing system including
at least one I/O device,
an I/O switch to which the I/O device is coupled,
a plurality of server apparatuses coupled to the I/O switch and capable of constructing a cluster,
the management server managing the at least one I/O device, the I/O switch, and the plurality of server apparatuses, in the information processing system the at least one I/O device having a function to loopback a heart beat signal transmitted from one of the server apparatuses to another one of the server apparatuses,
the management server comprising:
a heart beat path generating part that stores information on whether or not an identifier and a coupling port of the I/O switch to which the server apparatus and the I/O device are coupled, each of the I/O devices being enabled to use the loopback function for the heart beat signal, and selects one of the I/O devices enabled to use the loopback function and generates, as a path for the heart beat signal in the cluster, a path including a selected I/O device as a loopback point, when the cluster is configured between the server apparatuses; and
an I/O device control part that sets the I/O device so that the selected I/O device performs loopback of the heart beat signal along the path.

2. The management server according to claim 1,
wherein the management server
stores, as path information of the heart beat signal,
a MAC (media access control) address of the I/O device that is to be the loopback point,
the identifier and the coupling port of the I/O switch to which the I/O device that is to be the loopback point is coupled,
and the identifier and the coupling port ID of the I/O switch to which the server apparatus as a loopback destination of the heart beat signal of the I/O device that is to be the loopback point is coupled, and
the I/O device control part causes the selected I/O device to store the identifier and the coupling port ID of the I/O switch to which the server apparatus as the loopback destination is coupled.

3. The management server according to claim 2,
wherein the management server is
capable of setting a plurality of MAC addresses of the respective I/O devices enabled to use the loopback function, and
capable of storing, in association with each of the MAC addresses, the identifier and the coupling port ID of the I/O switch to which the server apparatus as the loopback destination is coupled.

4. The management server according to claim 1, further comprising:
a hardware status check part that checks a status of the I/O device allocated to the server apparatus functioning as a takeover apparatus when a fail-over between the server apparatuses is performed in a case of disruption of the heart beat signal to be transmitted and received between the server apparatuses, and that deters the fail-over when there is an anomaly in the I/O device.

5. The management server according to claim 1, further comprising:
an I/O device blocking part that blocks a port of the I/O switch when there is a failure in a cluster resource of the server apparatus, the port of the I/O switch being coupled to the I/O device coupled to the cluster resource of the server apparatus with the failure.

6. A cluster management method for an information processing system which includes at least one I/O device, an I/O switch to which the I/O device is coupled, a plurality of server apparatuses coupled to the I/O switch and capable of constructing a cluster, the management server managing the at least one I/O device, the I/O switch, and the server apparatuses, in the information processing system the at least one I/O device having a function to loopback a heart beat signal transmitted from one of the server apparatuses to another one of the server apparatuses, the method comprising the steps of:
storing an identifier and a coupling port ID of the I/O switch to which the server apparatus and the I/O device are coupled;
storing information as to whether or not each of the I/O devices is enabled to use the loopback function for the heart beat signal;
selecting one of the I/O devices enabled to use the loopback function and generates, as a path for the heart beat signal in the cluster, a path including a selected I/O device as a loopback point, when the cluster is configured between the server apparatuses; and
setting the I/O device so that the selected I/O device performs loopback of the heart beat signal along the path.

7. The cluster management method according to claim 6,
wherein the method further comprising the steps of:
storing, as path information of the heart beat signal,
a MAC address of the I/O device that is to be the loopback point,
the identifier and the coupling port of the I/O switch to which the I/O device that is to be the loopback point is coupled,
and the identifier and the coupling port ID of the I/O switch to which the server apparatus as a loopback destination of the heart beat signal of the I/O device that is to be the loopback point is coupled; and
making the I/O device store the identifier and the coupling port ID of the I/O switch to which the server apparatus as the loopback destination is coupled.

8. The cluster management method according to claim 7,
wherein the I/O device enabled to use the loopback function is
capable of setting a plurality of media access control addresses of the respective I/O devices having the loopback function available, and
capable of storing, in association with each of the MAC addresses, the identifier and the coupling port ID of the I/O switch to which the server apparatus as the loopback destination is coupled.

9. The cluster management method according to claim 6, further comprising the steps of:
checking a status of the I/O device allocated to the server apparatus functioning as a takeover apparatus when a fail-over between the server apparatuses is performed in a case of disruption of the heart beat signal to be transmitted and received between the server apparatuses; and
deterring the fail-over when there is an anomaly in the I/O device.

10. The cluster management method according to claim 6, the method further comprising the steps of:
blocking the port of the I/O switch when there is a failure in a cluster resource of the server apparatus, the port of the I/O switch being coupled to the I/O device coupled to the cluster resource of the server apparatus with the failure.
